(19) United States
(12) Patent Application Publication
(10) Pub. No.: US 2008/0297544 A1
(43) Pub. Date: Dec. 4, 2008

(54) METHOD FOR DETECTING RESOLUTION AND TIMING CONTROLLER

(75) Inventor: Ming-Sung Huang, Hsin Chu County (TW)

Correspondence Address: Muncy, Geissler, Olds & Lowe, PLLC, P.O. BOX 1364, FAIRFAX, VA, 22038-1364, US

(73) Assignee: Etron Technology, Inc.

(21) Appl. No.: 12/047,764

(22) Filed: Mar. 13, 2008

(30) Foreign Application Priority Data
May 31, 2007 (TW) 096119431

(51) Int. Cl. G09G 5/02

(52) U.S. Cl. 345/699; 345/3.4

(57) ABSTRACT

The invention discloses a method for detecting resolution and a timing controller. The method includes following steps: first, receiving a set of image control signals; judging resolution of image data. Wherein, the resolution of the image data includes a resolution of first dimension and a resolution of second dimension. The timing controller receives image data and a set of image control signals. The timing controller includes a resolution detecting circuit and a timing control unit.

### BACKGROUND OF THE INVENTION

(a) Field of the Invention

The invention relates to display technology, particularly to a method for detecting the resolution of image data and a timing controller for automatically detecting the resolution of image data.

(b) Description of the Related Art

In general, a flat display device, such as a liquid crystal display having superior attributes like high image quality, space saving, low power consumption, no radiation, and so forth, has gradually become the mainstream in the market. The timing controller is one of the important components in the liquid crystal display and is to control the timing of the peripheral circuits (such as: the gate controller and the source controller) of the liquid crystal display according to the resolution of the image data transmitted from the scaling control circuit (Scaler).

In general, the timing controller is designed to correspond to the pre-determined resolution of the display panel. In other words, if a timing controller is applied in a liquid crystal display panel having 800×600 resolution, this timing controller cannot be utilized in display panel having other resolutions, such as: 1024×768 or 1280×1024, and so forth. Therefore, suppliers must design different timing controllers to target at the different resolution specifications of the liquid crystal display panel.

In order to conveniently utilize the general timing controller for the display panel, suppliers ever provided the timing controller supporting two types of resolutions of the panel. One additional pin is added in such a timing controller and the pin is utilized to set the resolution. When the pin receives a signal at the high voltage level, the timing controller will operate in a first resolution; and when the pin receives a signal at the low voltage level, the timing controller will operate in a second resolution. However, in order to increase the selectable resolutions of the timing controller, increasing the number of pins becomes necessary. However, this causes difficulties in the layout of the printed circuit board and the interference to the circuit is likely possible.

### BRIEF SUMMARY OF THE INVENTION

In light of the above mentioned problem, one object of the invention is to provide a method for detecting resolution of image data and a timing controller for automatically detecting the resolution of image data. The original signal is utilized to determine automatically the resolution of the image data of the front end circuit (such as: the scaling control circuit) without increasing circuit layout area. Thus, the problems in the prior art are solved, utilizing the timing controller becomes convenient, and reducing the production cost is achieved.

Another object of the invention is to provide a method for detecting resolution of image data and a timing controller for automatically detecting the resolution of image data, that can be comprehensively applied in flat display panels having different resolutions.

Another object of the invention is to provide a method for detecting resolution of image data and a timing controller for automatically detecting the resolution of image data to spare the cost in research and development.

In order to achieve the above-mentioned or other objects, one embodiment of the invention provides a method for detecting resolution of image data. The method comprises the following steps. At first, a set of image control signals is received. Then, the resolution of the image data is determined according to the set of image control signals. The resolution comprises the resolution of a first dimension and the resolution of a second dimension. As the set of image control signals comprises a first reference signal, the resolution of the first dimension or the resolution of the second dimension is determined according to the attribute of the first reference signal.

Furthermore, one embodiment of the invention provides a timing controller for automatically detecting the resolution of image data. The timing controller receives the image data and a set of image control signals and this timing controller comprises a resolution detecting circuit and a timing control unit. The resolution detecting circuit determines the resolution of the image data according to the set of image control signals, wherein the resolution comprises the resolution of the first dimension and the resolution of the second dimension. The timing control unit then generates a timing control signal according to the resolution of the first dimension and the resolution of the second dimension. The resolution detecting circuit comprises a first determining circuit and a second determining circuit. When the set of image control signal comprises a first reference signal, the first determining circuit receives the first reference signal and generates the resolution of the first dimension according to the enabling period of the first reference signal. The second determining circuit also receives the first reference signal and generates the resolution of the second dimension according to the number of times the first reference signal is enabled within a pre-determined time.

The method for detecting resolution of image data and the timing controller for automatically detecting the resolution of image data according to one embodiment of the invention utilize the attribute of the reference signal in the inputted image control signal to determine the resolution of the input image data. Since the image data outputted by the front end circuit needs to match the resolution of the panel, the technique according to the invention can use a single timing controller to support display panels having multiple resolutions and thus the production cost of the timing controller can be reduced.

### BRIEF DESCRIPTION OF THE DRAWINGS

FIG. 1 shows a schematic diagram illustrating the display system according to one embodiment of the invention.

FIG. 2 shows a schematic diagram illustrating the resolution detecting circuit according to one embodiment of the invention.

FIG. 3 shows the signal timing diagram of the timing controller and the operation of the resolution detecting circuit according to one embodiment of the invention.

FIG. 4 shows a flow chart of the method for detecting resolution according to one embodiment of the invention.

### DETAILED DESCRIPTION OF THE INVENTION

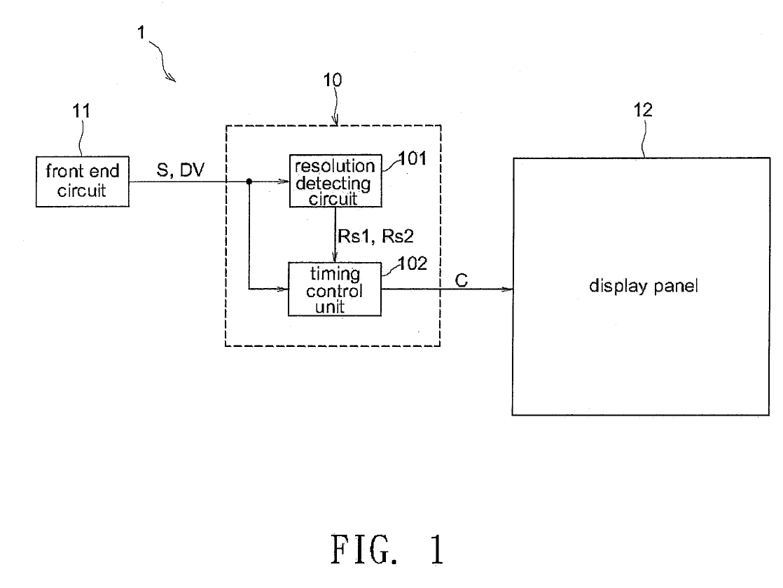

FIG. 1 shows a schematic diagram illustrating the display system according to one embodiment of the invention. The display system 1 comprises a timing controller 10 that can detect the resolution of image data automatically, a front end circuit 11 (such as the scaling integrated circuit (Scaler)), and a display panel 12. Generally, the display panel 12 has a predetermined resolution. The front end circuit 11 outputs the image data DV and a set of image control signals S to the timing controller 10. The set of image control signals S comprises a plurality of reference signals Rf (not shown in the figure). The plurality of reference signals can be the horizontal synchronizing signal Hs, the vertical synchronizing signal Vs, the data enabling signal DE, or the base band clock signal CK. Then, the timing controller 10 receives the set of image control signals S and the image data DV, and controls the source drive unit and the gate drive unit of the display panel and the timing of the display panel peripheral circuits according to the set of image control signals S to display the image. It should be noted that, in other embodiments of the invention, the set of the image control signals S outputted by the front end circuit 11 need not include the horizontal synchronizing signal Hs and the vertical synchronizing signal Vs. The horizontal synchronizing signal Hs and the vertical synchronizing signal Vs can be generated from the internal circuit of the timing controller 10.

In one embodiment of the invention, the timing controller 10 comprises a resolution detecting circuit 101 and a timing control unit 102. The resolution detecting circuit 101 receives the set of image control signals S and the image data DV and thereby determines the resolution of the image data DV according to the set of image control signals S. The resolution of the image data DV comprises the resolution of the first dimension Rs1 and the resolution of the second dimension Rs2.

The timing control unit 102 receives the set of image control signals S and the image data DV and generates a timing control signal C transmitted to the display panel 12 according to the resolution of the first dimension Rs1 and the resolution of the second dimension Rs2 to determine the display timing of the display panel 12.

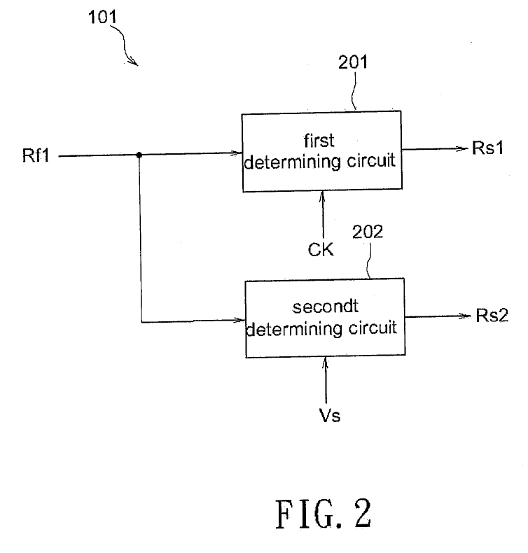

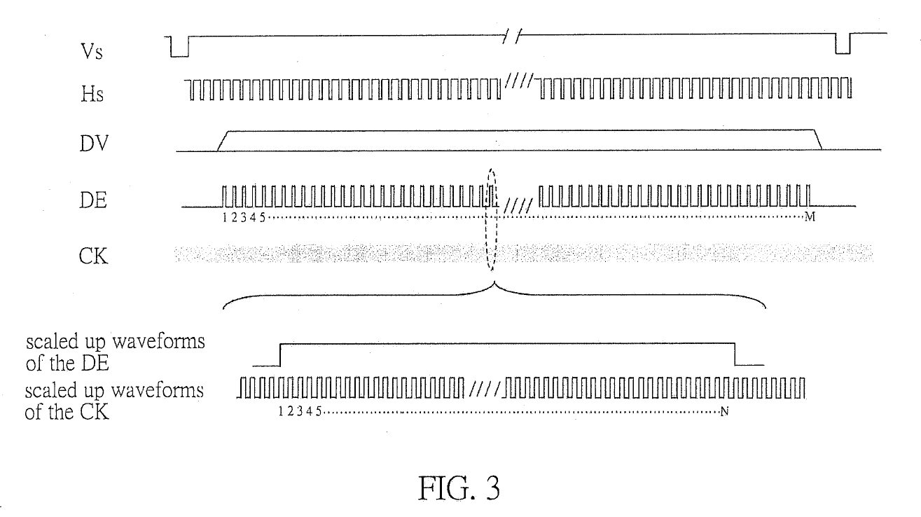

FIG. 2 shows a schematic diagram illustrating the resolution detecting circuit 101 according to one embodiment of the invention. In the figure, the resolution detecting circuit 101 comprises a first determining circuit 201 and a second determining circuit 202. FIG. 3 shows the signal timing diagrams of the timing controller 10 and the resolution detecting circuit 101 while operating according to one embodiment of the invention.

Please refer to FIGS. 1, 2, and 3 simultaneously.

At first, as shown in FIG. 2, the first determining circuit 201 receives the first reference signal Rf1 outputted by the front end circuit 11 and generates the above-mentioned resolution of the first dimension Rs1 according to the enabling period of the first reference signal Rf1. The second determining circuit 202 also receives the first reference signal Rf1, and generates the resolution of the second dimension Rs2 according to the number of times the first reference signal Rf1 is enabled within a pre-determined time. Of course, the second determining circuit 202 can also generate the resolution of the second dimension Rs2 according to the resolution of the first dimension Rs1.

In one embodiment of the invention, the first determining circuit 201 can be a horizontal resolution determining circuit, the second determining circuit 202 can be a vertical resolution determining circuit, and the first reference signal Rf1 can be the above-mentioned data enabling signal DE or the horizontal synchronizing signal Hs. It should be noted that the data enabling signal DE and the horizontal synchronizing signal Hs operate in synchronization with the image data DV of the image display picture.

The data enabling signal DE is thus used as an example in the following descriptions. As shown in FIG. 3, each time the data enabling signal DE is in the enabled status means that the data of one scanning line is transmitted from the front end circuit 11 to the timing controller 10. Therefore, the second determining circuit 202 shown in FIG. 2 can determine the resolution of the second dimension Rs2 (i.e. the vertical resolution) of the image data DV just according to the number of times the data enabling signal DE is enabled within a pre-determined time (such as: one frame time) of the image data.

In one embodiment of the invention, it is assumed that the set of image control signals S comprises a vertical synchronizing signal Vs and the first reference signal Rf1 is a data enabling signal DE. Then, the second determining circuit 202 will receive the data enabling signal DE and the vertical synchronizing signal Vs. As shown in FIG. 3, the pre-determined time required to determine the resolution of the second dimension Rs2 (the vertical resolution) according to the first reference signal Rf1 (the data enabling signal DE) is the time while the voltage value of the vertical synchronizing signal Vs is kept at a first voltage level within one period, such as: the period between the end of a frame and the start of the next frame of the image data DV.

In one embodiment of the invention, it is assumed that the set of image control signals S comprises a base band clock signal CK and the first reference signal Rf1 is a data enabling signal DE. Please refer to the data enabling signal DE shown as the dotted line in FIG. 3 and the scaled up waveforms of the DE and the CK shown at the bottom of the figure. As the data enabling signal DE is enabled each time, the data of one scanning line is transmitted to the timing controller 10 once. Each time the base band clock signal CK is enabled means that the data of one pixel of the scanning line will be transmitted by the front end circuit 11. Thus, the operation of the first determining circuit 201 is to receive the base band clock signal CK and the first reference signal Rf1 (the data enabling signal DE) and to generate the resolution of the first dimension (i.e. the horizontal resolution) according to the number of times the base band clock signal CK is enabled while the data enabling signal DE is enabled.

For example, it is assumed that the inputted image data DV is the data having a resolution of 1280×1024. The second determining circuit 202 starts to count the number of times the first reference signal Rf1 (the data enabling signal DE) is enabled while the vertical synchronizing signal Vs, as shown at the top of FIG. 3, switches from the low voltage level 0 into the high voltage level 1. The second determining circuit 202 keeps counting and then stops when the vertical synchronizing signal Vs switches from the high voltage level 1 into the low voltage level 0, and thereby derives the resolution of the second dimension Rs2 (the vertical resolution)=1024. Correspondingly, the first determining circuit 201 counts the number of times the base band clock signal Ck is enabled while the first reference signal Rf1 (the data enabling signal DE) is enabled so as to derive the resolution of a first dimension Rs1 (the horizontal resolution)=1280. Then, the resolution detecting unit 101 outputs the resolution of the first dimension Rs1=1280 and the resolution of the second dimension Rs2=1024 as the references for the timing control unit 102. Then, the timing control unit 102 receives the resolutions of the first and the second dimensions Rs1 and Rs2 and selects the control parameters corresponding to the resolution 1280×1024 from the build-in multiple control parameters to generate the timing control signal C. Thus, the timing of the display panel 12 is accurately controlled according to the resolution of the image data DV. Therefore, the effect of displaying the image correctly is achieved.

It should be noted that the circuit and the design method to build-in multiple build-in parameters in the timing control unit 102 is well known technique. Thus, further details will not be repeated hereinafter. Although the above-mentioned embodiment counts the number of times the base band clock signal CK is enabled so as to determine the horizontal resolution, it can be understood by those who are skilled in the art that the above-mentioned example is only one example of the invention. As long as the relation between the data enabling signal DE and the horizontal resolution is known, other clock signals having frequencies different from the base band clock signal can also be utilized for detection. Furthermore, in another embodiment of the invention, the technique of the invention only needs to estimate any possible data that can be derived from the enabling period of the data enabling signal DE and then the horizontal resolution of the image data DV can be determined according to the enabling period(such as: the length of the enabling period).

Furthermore, the invention can also determine the resolution by utilizing other signals in the set of image control signals S. For example, in FIG. 3, the resolution of the second dimension (the vertical resolution) of the image data DV can also be determined by counting the number of times the horizontal synchronizing signal Hs is enabled while the vertical synchronizing signal Vs is at the high voltage level. Furthermore, in another embodiment of the invention, the technique of the invention only needs to count the number of times the base band clock signal CK is enabled during the enabling period of the horizontal synchronizing signal Hs so that the resolution of the first dimension (the horizontal resolution) of the image data DV can be determined according to the enabling period. The main reason is because that the difference between its resolutions is so large for liquid crystal displays having different resolution (such as: 800×600, 1024×768, or 1280×1024, or the like). Thus, even though there are differences between the enabling period of the horizontal synchronizing signal Hs and the enabling period of the data enabling signal DE, such difference will not influence the determination of the resolution. For example, the resolution of a first dimension (the horizontal resolution)=800 is derived by counting the number of times the base band clock signal CK is enabled during the enabling period of the data enabling signal DE while the value determined by counting the number of times the base band clock signal CK is enabled during the enabling period of the Hs is 890. The resolution of the first dimension (the horizontal resolution)=800 can still be derived by utilizing the number of times the base band clock signal CK is enabled during the enabling period of the Hs together with looking up the lookup table. Thus, the invention is not limited to the above-mentioned embodiments.

In addition, after the resolution of the first dimension (the horizontal resolution) of the image data DV is derived, the resolution of the second dimension (the vertical resolution) can be estimated without counting, according to the invention, by utilizing the build-in table-look-up method (and vise versa). Because most of the horizontal resolution and the vertical resolution appears in pairs with each other, such as: the 800×600, 1024×768 or 1280×1024 resolutions of liquid crystal display panel, once the horizontal resolution is known to be 800, the vertical resolution can be derived to be 600 by utilizing the build-in lookup table.

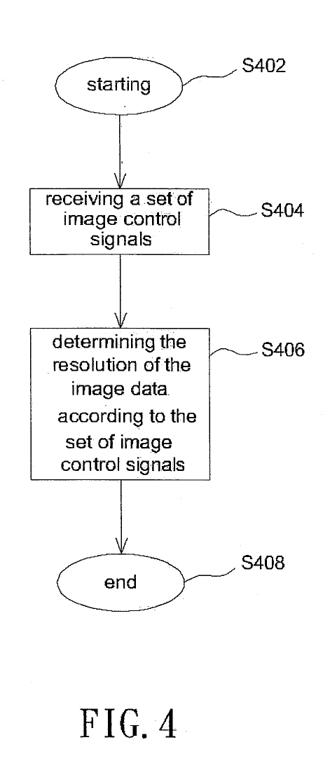

FIG. 4 shows a flow chart of the method for detecting resolution according to one embodiment of the invention. The method comprises the following steps:

Step S402: starting;

Step S404: receiving a set of image control signals;

Step S406: determining the resolution of the image data according to the set of image control signals, wherein the resolution comprises the resolution of a first dimension and the resolution of a second dimension; and

Step S408: end.

It should be noted that, when the set of image control signals comprises a first reference signal, the step S406 will determine the resolution of the first dimension according to the first reference signal wherein the first reference signal can be a data enabling signal or a horizontal synchronizing signal. If the set of image control signals further comprises a base band clock signal, the step S406 will generate the resolution of the first dimension according to the number of times the base band clock signal is enabled while the first reference signal is enabled, and the resolution of the first dimension is a horizontal resolution.

Furthermore, the step S406 can also determine the resolution of the second dimension according to the number of times the first reference signal is enabled within a pre-determined time and the resolution of the second dimension is a vertical resolution. The pre-determined time can be one frame time or the time while the voltage value of the vertical synchronizing signal is kept at a first voltage level within one period.

On the other hand, the method for detecting the resolution of image data according to another embodiment of the invention can also generate the resolution of the second dimension by the table-look-up method according to the resolution of the first dimension of the step S406.

In conclusion, the method for detecting resolution of image data and the timing controller that detects the resolution of image data automatically according to the invention utilize the attribute of the reference signal Rf of the inputted image control signal S to determine the resolution of the input image data. Since the image data outputted by the front end circuit needs to match the resolution of the panel, the technique according to the invention can utilize a single timing controller to support display panels having multiple resolutions and thereby the production cost of the timing controller can be reduced.

Although the present invention has been fully described by way of examples with reference to the accompanying drawings, it should not be construed as any limitation on the implementation of the invention. Various equivalent changes and modifications of the shape, scope, characteristics, and spirit as described by the claims of the present invention are to be encompassed by the scope of the present invention.

What is claimed is:

1. A method for detecting resolution of image data, the method comprising:
(a) receiving a set of image control signals; and;
(b) determining the resolution of the image data according to the set of image control signals, wherein the resolution comprises the resolution of a first dimension and the resolution of a second dimension.

2. The method according to claim 1, wherein the set of image control signals comprises a first reference signal and the step (b) determines the resolution of the first dimension according to the first reference signal.

3. The method according to claim 2, wherein the set of image control signals further comprises a base band clock signal, the step (b) generates the resolution of the first dimension according to the number of times the base band clock signal is enabled while the first reference signal is enabled, and the resolution of the first dimension is a horizontal resolution.

4. The method according to claim 2, wherein the step (b) determines the resolution of the second dimension according to the number of times the first reference signal is enabled within a pre-determined time and the resolution of the second dimension is a vertical resolution.

5. The method according to claim 4, wherein the pre-determined time is one frame time of the image data.

6. The method according to claim 4, wherein the set of image control signals comprises a vertical synchronizing signal and the pre-determined time is the duration that the voltage value of the vertical synchronizing signal is at a first voltage level within one period.

7. The method according to claim 2, further comprising:
generating the resolution of the second dimension according to the first resolution by the table-look-up method.

8. The method according to claim 2, wherein the first reference signal is a data enabling signal.

9. The method according to claim 2, wherein the first reference signal is a horizontal synchronizing signal.

10. A timing controller for automatically detecting the resolution of image data, receiving the image data and a set of image control signals, the timing controller comprising:
a resolution detecting circuit for determining the resolution of the image data according to the set of image control signals, wherein the resolution comprises the resolution of a first dimension and the resolution of a second dimension; and
a timing control unit for generating a timing control signal according to the resolution of the first dimension and the resolution of the second dimension.

11. The timing controller according to claim 10, wherein the set of image control signals comprises a first reference signal and the resolution detecting circuit comprises:
a first determining circuit for receiving the first reference signal, generating the resolution of the first dimension according to the enabling period of the first reference signal; and
a second determining circuit for receiving the first reference signal and generating the resolution of the second dimension according to the number of times the first reference signal is enabled within a pre-determined time.

12. The timing controller according to claim 11, wherein the first determining circuit further receives a base band clock signal and generates the resolution of the first dimension according to the number of times the base band clock signal is enabled while the first reference signal is enabled.

13. The timing controller according to claim 12, wherein the first reference signal is a data enabling signal.

14. The timing controller according to claim 12, wherein the first reference signal is a horizontal synchronizing signal.

15. The timing controller according to claim 11, wherein the pre-determined time is one frame time of the image data and the first reference signal is a data enabling signal.

16. The timing controller according to claim 11, wherein the set of image control signals comprises a vertical synchronizing signal, the pre-determined time is the duration that the voltage value of the vertical synchronizing signal is at a first voltage level within one period, and the first reference signal is a data enabling signal.

17. The timing controller according to claim 10, wherein the set of image control signals comprises a first reference signal and the resolution detecting circuit comprises:
a first determining circuit for receiving the first reference signal and generating the resolution of the first dimension according to the first reference signal; and
a second determining circuit for generating the resolution of the second dimension according to the resolution of the first dimension.

18. The timing controller according to claim 17, wherein the first determining circuit further receives a base band clock signal and generates the resolution of the first dimension according to the number of times the base band clock signal is enabled while the first reference signal is enabled.

19. The timing controller according to claim 17, wherein the first determining circuit is for generating the resolution of the first dimension according to the number of times the first reference signal is enabled within one frame time of the image data.

20. The timing controller according to claim 17, wherein the first reference signal is a data enabling signal.
